(19) United States
(12) Patent Application Publication
(10) Pub. No.: US 2016/0019282 A1
(43) Pub. Date: Jan. 21, 2016

(54) DISCOVERY MANAGEMENT METHOD AND SYSTEM

(71) Applicant: AXIOM GLOBAL INC., New York, NY (US)

(72) Inventors: David D. LEWIS, Highland Park, IL (US); Anupam RAZDAN, Chicago, IL (US); Michael HAGEMANN, Chicago, IL (US); Gabriel GERRING, Chicago, IL (US); Conor MILLER, Washington, DC (US)

(21) Appl. No.: 14/332,428

(22) Filed: Jul. 16, 2014

(51) Int. Cl. G06F 17/30; G06N 99/00

(52) U.S. Cl. CPC G06F 17/30598; G06N 99/005

(57) ABSTRACT

A computer-implemented method and system are provided for discovery management. The method involves specifying a set of categories; receiving a collection of records; separating the collection of records into at least a first portion of records and a second portion of records; classifying the first portion of records using supervised machine learning; and classifying the second portion of records by other than supervised machine learning. The method further involves creating a certification test set by drawing a simple random sample from the collection of records; manually labeling the certification test set by associating each record in the certification test set with a desired category for that record; and comparing the category assigned to each record of the certification test set by the classifying of the collection with the category assigned to each record of the certification test set by the manual labeling of certification test set.

### BACKGROUND OF THE DISCLOSURE

1. Field of the Disclosure

This disclosure relates to discovery in the context of litigation and other situations where disclosure of stored information is compelled or required by law or necessity, and more particularly, to a method for managing and/or controlling the time, costs, and quality of production by leveraging supervised machine learning.

2. Description of the Related Art

Companies and individuals are increasingly subject to legal demands for disclosure of paper documents and computer files and other electronically stored information. Electronically stored information includes all computer-generated files, and also includes all other types of digital and electronically stored information, such as voice mails recordings and the like. The legal demands for disclosure arise in civil and criminal litigation, government investigations, regulatory compliance, mergers and acquisitions, and other situations where disclosure of information is required by law, necessity, or research.

The retrieval of relevant information stored in large, disorganized collections of boxes and computer files has proven to be extremely difficult and expensive to accomplish. The task has continuously grown more difficult as businesses and governments move from paper records to electronically stored information. Today most organizations store, in addition to large quantities of paper documents, large quantities of electronically stored information, now commonly measured in terabytes of information, most all of which must be searched in response to legal obligation to make disclosure of information. The search and retrieval of relevant paper documents and electronically stored information from these vast, disorganized boxes and stores of data frequently places a tremendous monetary, time, and interruption burden upon the persons and entities responding to these information disclosure demands.

Predictive coding software has been developed that facilitates the search and retrieval of relevant electronically stored information. Such predictive coding software is available commercially, for example, from Equivio. Predictive coding facilitates prioritization of electronically stored information. However, predictive coding in some instances may provide estimates only of the effectiveness of the predictive model and not the production set. In other instances, where predictive coding may provide estimates of production set effectiveness, it does so too late to inform of most decisions, or uses effectiveness measures which do not provide the information necessary for decision making.

What is needed is a method and system that accounts for non-predictive coding prioritization, together with predictive coding prioritization, in making decisions, in particular, for making statistically valid and timely estimates of current and projected production set recall, along with other effectiveness measures. These estimates should give credit for prioritization of information by methods other than predictive coding. These estimates should inform key decisions including, for example, when to stop training, when to put some version of the predictive model into use, what threshold to use for a predictive model, how many documents to queue for review, when to stop the review, and the like.

The present disclosure provides many advantages, which shall become apparent as described below.

### SUMMARY OF THE DISCLOSURE

This disclosure relates in part to a computer-implemented method. The method involves specifying a set of categories; receiving a collection of records; separating the collection of records into at least a first portion of records and a second portion of records; classifying the first portion of records using supervised machine learning; and classifying the second portion of records by other than supervised machine learning. The method also involves creating a certification test set by drawing a simple random sample from the collection of records; manually labeling the certification test set by associating each record in the certification test set with a desired category for that record; and comparing the category assigned to each record of the certification test set by the classifying of the collection with the category assigned to each record of the certification test set by the manual labeling of certification test set. The method further involves computing an estimate of the effectiveness of the classification of the collection.

This disclosure yet further relates in part to a computer-implemented system. The system includes a repository comprising a collection of records; and one or more processors configured to: specify a set of categories; receive the collection of records; separate the collection of records into at least a first portion of records and a second portion of records; classify the first portion of records using supervised machine learning; and classify the second portion of records using other than supervised machine learning. The one or more processors are also configured to: create a certification test set by drawing a simple random sample from the collection of records; allow for manual labeling the certification test set by associating each record in the certification test set with a desired category for that record; and compare the category assigned to each record of the certification test set by the classifying of the collection with the category assigned to each record of the certification test set by the manual labeling of the certification test set. The one or more processors are further configured to compute an estimate of the effectiveness of the classification of the collection.

Advantages afforded by the method and system of this disclosure include, for example, using predictive coding to substantially reduce the total cost of review for responsiveness, compensating for limitations and peculiarities of vendor software and vendor processes, leading to production sets that meet specified targets for effectiveness, producing unbiased statistical estimates of the effectiveness of the production set produced, allowing (when possible) changing a collection (including additions, deletions, splitting, and changes in the responsiveness definition) while maintaining the quality of review and validity of statistical estimates, and producing reports that aid in defending the process against potential legal challenges to its quality and fairness.

Further objects, features and advantages of the present disclosure will be understood by reference to the following drawings and detailed description.

### BRIEF DESCRIPTION OF THE DRAWINGS

FIG. 1 depicts the eleven high level phases involved in the method of this disclosure.

FIG. 2 depicts a process flow and decision tree diagram including the eleven high level phases involved in the method of this disclosure.

FIG. 3 depicts who is in control in the eleven high level phases involved in the method of this disclosure.

FIG. 4 depicts what is being offered in the eleven high level phases involved in the method of this disclosure.

A component or a feature that is common to more than one drawing is indicated with the same reference number in each drawing.

### DESCRIPTION OF THE PREFERRED EMBODIMENTS

Several terms are used herein for describing the discovery management process of this disclosure. For purposes of this disclosure, those terms have the meanings indicated below.

“Batches” means record groupings based on selected criteria that are distributed to reviewers for record coding.

“Category” is a distinction that either holds or doesn't hold for a record. Categories are often grouped into mutually exclusive and collectively exhaustive groups called “Discriminations”. For instance, if every record is either responsive or nonresponsive, then one might define a discrimination RESPONSIVENESS consisting of the two categories RESPONSIVE and NONRESPONSIVE. A classification process for RESPONSIVENESS, whether carried out by person or software or both, would assign each record to either the category RESPONSIVE or the category NONRESPONSIVE.

“Certification” means the process of evaluating and documenting the quality of the entire review process, including estimating the effectiveness of the Production Set and reporting to a client, if needed.

“Certification Test Set” means the test set used in estimating the effectiveness of the final Production Set.

“Collection” means the set of records loaded into the predictive coding platform.

“Labeled Set” means a set of records intended to play a particular role in a predictive coding process, where each record has been manually assigned to a category. In the discovery management process of this disclosure, the Training Set, Working Test Set, and Certification Test Set are the labeled sets used.

“Labeling” means manually assigning categories from one or more Discriminations to a record for the purpose of creating a Labeled Set. Labeling may be accomplished by choosing a category from a menu, by typing a category name, by indicating to the system that an automatically assigned category is correct, or by other means. All labeling doubles as review (since any responsive record found during labeling must be added to the Production Set), but not all review is necessarily used for labeling. Coding is the action of labeling a record as relevant or non-relevant, or the set of labels resulting from that action. Coding is sometimes interpreted narrowly to include only the result(s) of a manual review effort. Coding is sometimes interpreted more broadly to include automated or semi-automated labeling efforts. Coding is generally the term used in the legal industry, and labeling is the equivalent term in information retrieval.

“Gold Labels” means labeling of a set of records for the purpose of evaluating some other classification of the records. Gold Labels are also called “gold standard labels”, “ground truth labels”, “relevance judgments”, and a variety of other terms. In the discovery management process of this disclosure, the labels of test set records (i.e., the Working Test Set and Certification Test Set) are used as Gold Labels.

“Near-Miss Record” means a record that is not responsive, but which shares some characteristics with responsive records. Along with responsive records, near-misses are particularly useful for training.

Predictive Model” means a rule (often a mathematical function) that inputs a record and outputs a predictive score for the record. In the discovery management process of this disclosure, a Predictive Model outputs a predictive score, and a classifier (often formed by combining a Predictive Model with a threshold) outputs a predicted label.

“Predictive Score” means a number indicating how strongly a Predictive Model finds the evidence that the record belongs to a particular class. In e-discovery, the most common use of Predictive Models is to produce a numerical score which is higher the more likely the record is to be responsive. The Predictive Score is also called a relevance score, classification score, etc.

“Prioritization Constraints” means the factors, in addition to a Predictive Score, that influence the order in which records should be reviewed. These can include legal demands of the case, availability of reviewers with particular skills, etc.

“Production Set” means a set of records that will be delivered to requesting parties in a legal matter.

“Records” means any information or units of information or any discrete carriers of information that can be sampled from in accordance with this disclosure. Records can have links to other records. Examples of records include textual documents, images, audio recordings, electronic messages generated by people or systems, database records, and others.

“Review Pool” means a set of records that have been identified for review.

“Splitting” means separating the records in a Collection into two or more new Collections. The Labeled Sets associated with the Collection are typically split as well.

“Supervised machine learning” means any learning from labeled examples and includes, but is not limited to, predictive coding.

“Test Set” means a set of records used in estimating the effectiveness of a Predictive Model or of a set of classification decisions.

“Training” means the application of a supervised learning algorithm to a set of Labeled examples (i.e., records) in order to produce a Predictive Model.

“Training Set” means a set of Labeled records used by a supervised learning algorithm to produce a Predictive Model or classifier. In the discovery management process of this disclosure, the Training Set is one of the Labeled Sets used. In particular, a Training Set is a sample of records coded by one or more subject matter expert(s) as relevant or non-relevant, from which a machine learning algorithm then infers how to distinguish between relevant and non-relevant records beyond those in the Training Set.

“Verification Test Set” means the test set used in validating the effectiveness of the final Production Set.

Working Test Set” means a random sample of records used in estimating several quantities in the discovery management process of this disclosure, including richness, the effectiveness of Predictive Models, and the effectiveness of the Production Set. These estimates are used to make process management decisions. The Working Test Set is one the Labeled Sets used in the discovery management process of this disclosure, and in particular is one of the two test sets used.

As used herein, predictive coding is a form of technology-assisted review that uses supervised learning to extrapolate human coding decisions made on a subset of records to a larger collection of records. Predictive coding uses an iterative approach that trains a predictive model to imitate human coding decisions. In that way, predictive coding is similar to the systems that recommend products based on past purchases, or that choose advertisements to display based on past website or search engine clickthroughs.

Predictive coding is not a replacement for lawyers, or for human judgment in record review. Instead, predictive coding expands the reach of sound legal judgment. It produces a rule that can be applied automatically to millions of records, and can predict, with some degree of accuracy, what a lawyer's coding decision for a record would be.

Predictive coding is useful for both producing and receiving parties in e-discovery. Producing parties can use predictive coding to prioritize records for review, increase the quality of decisions, save manual review effort, and aid in review for privilege. Receiving parties can use predictive coding to aid in finding the most important records in a large mass of produced material.

The predictive coding software useful in the process of this disclosure is available commercially, for example, from Equivio. Illustrative predictive coding software useful in the process of this disclosure is described, for example, in U.S. Pat. Nos. 8,527,523 and 8,533,194, the disclosures of which are incorporated herein by reference in their entirety.

In accordance with this disclosure, a computer-implemented method is provided that involves specifying a set of categories; receiving a collection of records; separating the collection of records into at least a first portion of records and a second portion of records; classifying the first portion of records using supervised machine learning; and classifying the second portion of records by other than supervised machine learning. The method also involves creating a certification test set by drawing a simple random sample from the collection of records; manually labeling the certification test set by associating each record in the certification test set with a desired category for that record; and comparing the category assigned to each record of the certification test set by the classifying of the collection with the category assigned to each record of the certification test set by the manual labeling of certification test set. The method further involves computing an estimate of the effectiveness of the classification of the collection.

Classifying the first portion of records using supervised machine learning can involve producing a labeled working test set by: selecting an unlabeled working test set by drawing a random sample from the first portion of records; and manually labeling the working test set by associating each record in the unlabeled working test set with a desired category for that record. The classifying also involves producing a labeled training set by: selecting an unlabeled training set by selecting one or more records that are not in the working test set; and manually labeling the unlabeled training set by associating each record in the unlabeled training set with a desired classification of that record. The classifying further involves learning a classifier by applying supervised machine learning to the labeled training set; classifying the working test set by applying the classifier to the unlabeled working test set; comparing the labeled working test set and the classified working test set; and choosing whether or not to increase the unlabeled training set by selecting more records that are not in the working test set to produce a larger labeled training set based on the comparison of the labeled working test set and the classified working test set.

Classifying the collection of records can further involve creating a production set by consolidating all records from the first portion that were classified into one or more of the set of categories and the records from the second portion that were classified into one or more of the set of categories.

Classifying the collection of records can yet further involve producing a review set by consolidating records from the first portion that were classified into one or more of the set of categories and the records from the second portion that were classified into one or more of the set of categories; manually reviewing one or more of the records included in the review set and optionally replacing one or more of the categories assigned to those records with one or more different categories from the set of categories; and creating a production set from one or more of the records in the review set.

The working test set can be used to estimate the effectiveness of the review set. The measure of effectiveness can be recall, precision, Van Rijsbergen's F-measure, accuracy, error rate, or elusion. The working test set can also be used to estimate effectiveness of the production set and to choose whether or not to attempt certification based on the estimated effectiveness of the production set.

In accordance with this disclosure, a computer-implemented system is provided that includes a repository comprising a collection of records; and one or more processors configured to: specify a set of categories; receive the collection of records; separate the collection of records into at least a first portion of records and a second portion of records; classify the first portion of records using supervised machine learning; and classify the second portion of records using other than supervised machine learning. The one or more processors are also configured to: create a certification test set by drawing a simple random sample from the collection of records; allow for manual labeling the certification test set by associating each record in the certification test set with a desired category for that record; and compare the category assigned to each record of the certification test set by the classifying of the collection with the category assigned to each record of the certification test set by the manual labeling of the certification test set. The one or more processors are further configured to compute an estimate of the effectiveness of the classification of the collection.

The one or more processors can be configured to classify the first portion of records using supervised machine learning to: produce a labeled working test set by: selecting an unlabeled working test set by drawing a random sample from the first portion of records; and allow for manually labeling the working test set by associating each record in the unlabeled working test set with a desired category for that record. The one or more processors can be further configured to produce a labeled training set by: selecting an unlabeled training set by selecting one or more records that are not in the working test set; and allow for manually labeling the unlabeled training set by associating each record in the unlabeled training set with a desired classification of that record. The one or more processors can be yet further configured to learn a classifier by applying supervised machine learning to the labeled training set; classify the working test set by applying the classifier to the unlabeled working test set; compare the labeled working test set and the classified working test set; and choose whether or not to increase the unlabeled training set by selecting more records that are not in the working test set to produce a larger labeled training set based on the comparison of the labeled working test set and the classified working test set.

The one or more processors can be configured to classify the collection of records to create a production set by consolidating all records from the first portion that were classified into one or more of the set of categories and the records from the second portion that were classified into one or more of the set of categories.

The one or more processors can be configured to classify the collection of records to: produce a review set by consolidating records from the first portion that were classified into one or more of the set of categories and the records from the second portion that were classified into one or more of the set of categories; allow for manually reviewing one or more of the records included in the review set and optionally replacing one or more of the categories assigned to those records with one or more different categories from the set of categories; and create a production set from one or more of the records in the review set.

The one or more processors can be configured to use the working test set to estimate the effectiveness of the review set. The measure of effectiveness is recall, precision, Van Rijsbergen's F-measure, accuracy, error rate, or elusion. The one or more processors can be further configured to use the working test set to estimate the effectiveness of the production set; and choose whether or not to attempt certification based on the estimated effectiveness of the production set.

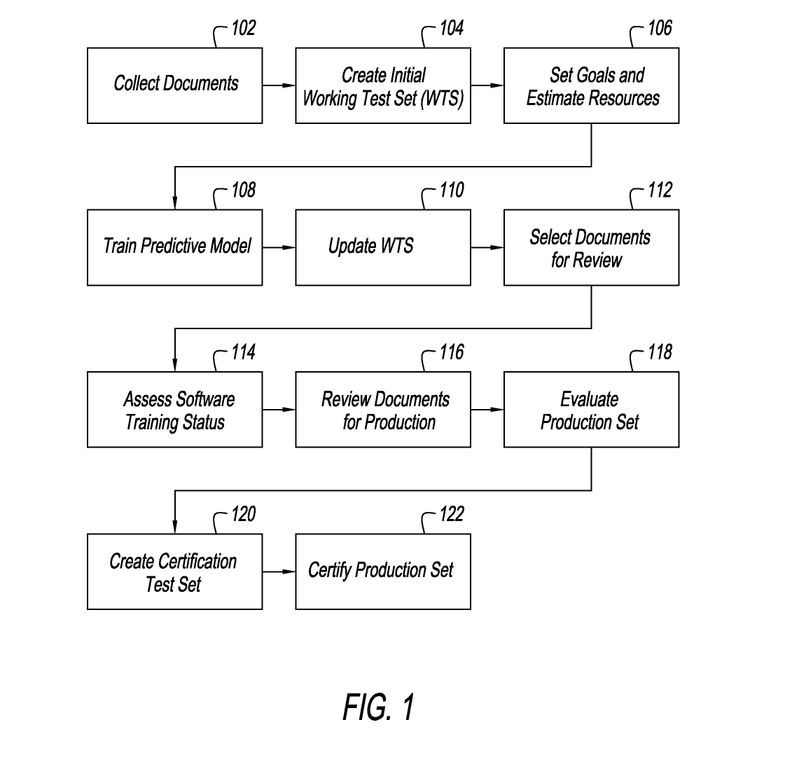

In particular, as shown in FIGS. 1-4, the method and system of this disclosure can be categorized into eleven phases or sub-processes as follows:

Phase 1 Creating the collection of records (e.g., documents) at 102

Phase 2 Creating initial working test set and estimating richness at 104

Phase 3 Setting effectiveness goals and projecting resource requirements at 106

Phase 4 Training the predictive model at 108

Phase 5 Updating the working test set at 110

Phase 6 Selecting records for review at 112

Phase 7 Deciding whether to halt training at 114

Phase 8 Reviewing records for production at 116

Phase 9 Evaluating the verification set and production set at 118

Phase 10 Creating the certification test set at 120

Phase 11 Certifying the verification set and production set at 122

The above phases are listed in a typical order, but the order is not strict. Phases can iterate, and multiple phases can be underway simultaneously at any point in time. For instance, selection (Phase 6) and review (Phase 8) of some important records might start as soon as they are collected, without waiting for any other phase. Creation of the Certification Test Set (Phase 10) might occur in parallel with Phases 4 to 9. Several iterations of Phases 4 to 7 are typical.

In addition, events in later phases may lead to redoing parts of earlier phases. For instance, information discovered during review may lead to changes in the definition of responsiveness, thus requiring relabeling of some records (Phases 4, 5, and 10). New records may be received at any time, and depending on how much they change the properties of the Collection, may lead to additional work in some or all phases of the process.

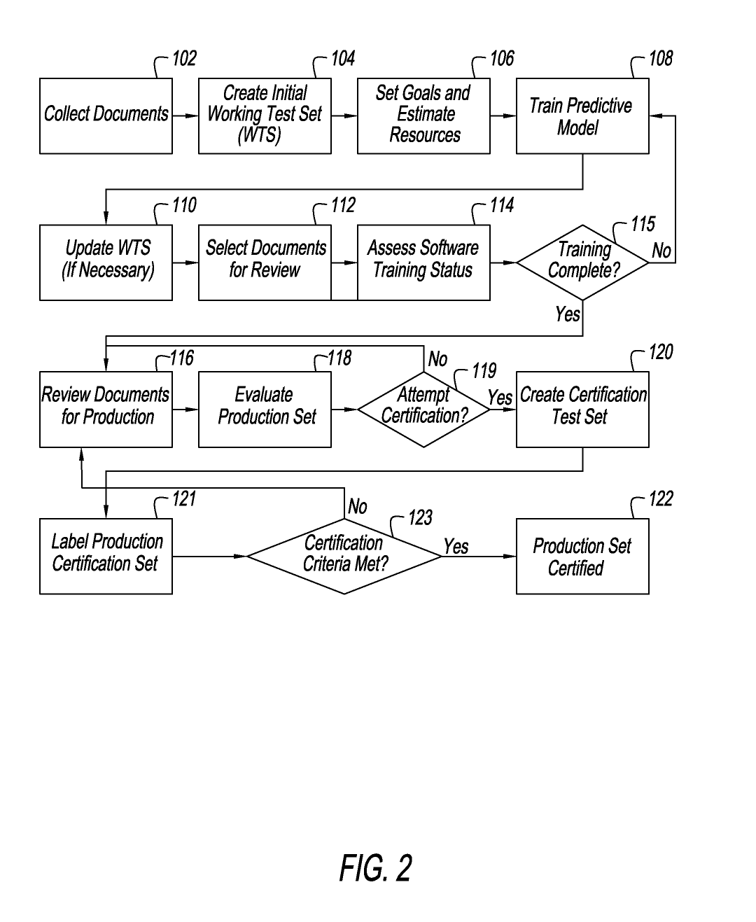

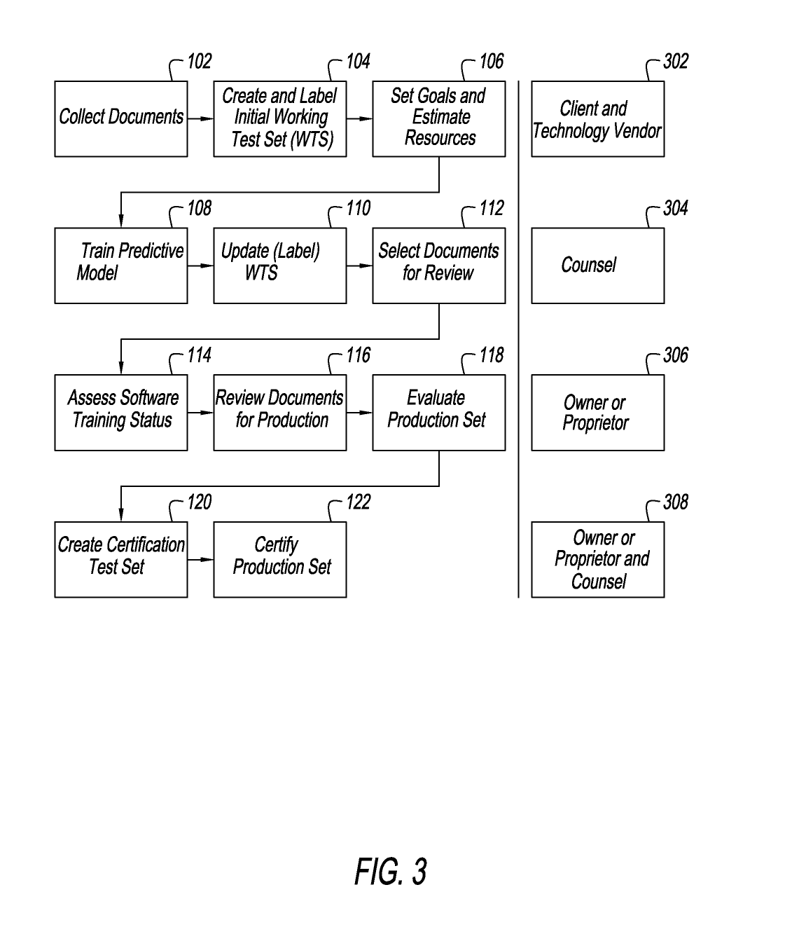

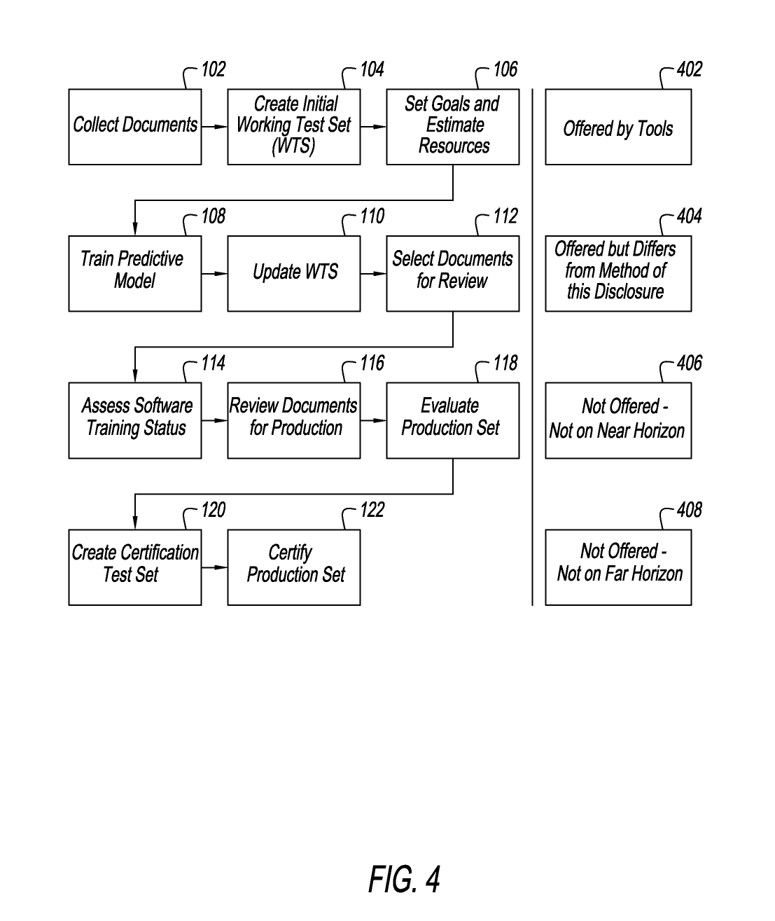

FIG. 1 depicts the eleven high level phases involved in the method of this disclosure. FIG. 2 depicts a process flow and decision tree diagram including the eleven high level phases involved in the method of this disclosure. FIG. 3 depicts who is in control and FIG. 4 depicts what is being offered in the eleven high level phases involved in the method of this disclosure.

Referring to FIGS. 1-4, Phase 1 at 102 involves the collection and processing of records. The records are typically collected by the client. The collected records are then transmitted to an entity for processing. The entity performs actions on the electronically stored information to allow for metadata preservation, itemization, normalization of format, and data reduction. The processing also involves filtering. For example, culling may be applied to reduce the set of records to a smaller collection. The processing also involves loading the collection into the predictive coding software and/or review software. In Phase 1, subsets of Collection and Non-Collection records can be identified by tagging and other means.

Culling involves the omission of collected records from the Collection based on normative (or negotiated) criteria. Culling can be a critical step in reducing the overall size of the Collection. In determining which filters to use, one needs to consider the risk of the filter removing responsive records.

In Phase 1, the client collects the material and provides to an eDiscovery technology entity. Statistics or metrics from anything are typically not used before Phase 1. Phase 1 is concerned only with records that are received for review. Phase 1 does not attempt to measure a client's responsibility for the overall collection, for example, what records were not included by the client in the collection.

In accordance with the process of this disclosure, similar records can be grouped together using “Near-Duping”, but not as part of the predictive coding process. Preferably, any exact duplicates are eliminated by the client before records are sent to the reviewer. True duplicates can be eliminated by the client before giving the review data to the reviewer, or by the reviewer if the reviewer had a prior phase of the review completed (remove records based on exact hash value/fingerprint when compared to previously reviewed records).

Referring to FIGS. 1-4, Phase 2 at 104 involves creating an initial Working Test Set (WTS) and estimating richness. In this stage, the first records are selected and labeled in creating the Working Test Set. For example, the first records can be selected by simple random sampling and the sample size can be max (200, 750 x fraction of collection). SME labels selected records. The richness of the collection is estimated (i.e., the proportion of responsive records in the Collection). In estimating richness of the collection, the inputs include the number of responsive records in the WTS and the total number of records in the WTS. The outputs include multiple confidence interval estimates of the richness. The lower confidence limit of the 95% Agresti-Coull interval is used as the value of richness when making process management decisions.

In Phase 2, an initial Working Test Set is created and richness (% responsiveness) of the population is estimated using predictive coding software.

The Working Test Set is used to estimate two types of quantities, namely, the richness of the Collection and effectiveness measures for classifications. The richness of the Collection is an estimate of the proportion of responsive records in the Collection and is important to setting effectiveness targets, estimating the resources necessary to produce Labeled Sets, and giving insight into the overall difficulty of the review project. For the effectiveness measures for classifications, the Working Test Set is used to produce estimates of effectiveness of components of the review process to aid decision making. It can used to evaluate the predictive model, other record selection methods, the Review Pool, the Verification Set and Production Set, and individual reviewers.

The Working Test Set is ideally a simple random sample from the Collection. Creating the initial version of the Working Test Set is typically done using the random sampling capabilities of either the predictive coding platform or the review platform, but might also be done using permanent random number (PRN) sampling externally or in the predictive coding platform.

Referring to FIGS. 1-4, Phase 3 at 106 involves setting effectiveness goals and projecting resource requirements. In this stage, a project manager or other responsible entity is tasked with setting effectiveness goals and projecting resource requirements. In particular, the project manager or other responsible entity inputs the effectiveness targets for the Production Set (as prescribed by the client or by counsel) including the target recall for the Production Set and the confidence level for recall estimates from the Working Test Set and the Certification Test Set. The project manager or other responsible entity computes the number of records in the Working Test Set and the Certification Test Set and the Training Set. The project manager or other responsible entity adjusts effectiveness goals and test set sizes if necessary. The project manager or other responsible entity then estimates the manual review resources that will be required for (a) the creation of the Labeled Sets (Working Test Set, Certification Test Set and Training Set), and (b) the manual review (i.e., validation) portion of the predictive coding process.

In Phase 3, the overall recall target for the review is set and the resources needed to achieve it are estimated. The client is a part of any discussions and so it is an iterative approach. Estimates are used for the richness of the collection which is the estimated responsiveness % of the records. The reviewer preferably works with the client in Phase 3 to determine the guiding recall target, balancing client risk, record review requirements, and cost pressures.

The process of this disclosure uses recall as an overall effectiveness target and also calculates total recall from overall record review (including linear, predictive coding, hard copy, etc.), and uses overall recall as an effectiveness measure to guide the review. The process also has a proportionality calculator.

An overall recall metric is used as a guide for calculating cost/time/risk based on that recall target and the records that are expected to be reviewed and the records that may be excluded from review. The process of this disclosure measures recall over overall review (both linear and predictive coding review), not the entire Collection.

Predictive coding makes use of several Labeled Sets, i.e. groups of records sampled or selected in a specified way and manually coded as either responsive or non-responsive. The Labeled Sets include the Training Set (records that are used to teach the software how to recognize responsive records), the Working Test Set (records that are used to make process management decisions), and the Certification Test Set (records used to provide the final estimate of the effectiveness of the Production Set).

These Labeled Sets are used for training the predictive model, evaluating it, and evaluating the review as a whole. The evaluation, along with the selection and labeling of these sets, occurs in Phase 3. Taking into account the Collection richness and the needs of the case, a target is specified for the recall of the Production Set, i.e. the minimum fraction of the responsive records required to be produced. The amount of uncertainty that can be tolerated in estimates is specified. Based on these targets, the resources necessary for producing the Labeled Sets can be estimated.

In an embodiment, recall and precision relevancy ratios can be used for estimation purposes in accordance with this disclosure. The recall relevancy ratio is the total number of relevant records retrieved divided by the total number of relevant records in the collection. The precision relevancy ratio is the total number of relevant records retrieved divided by the total number of retrieved records.

Referring to FIGS. 1-4, Phase 4 at 108 involves training the Predictive Model, i.e., incrementally select and label records for the Training Set, and apply supervised learning to the Training Set to produce a predictive model. This stage involves labeling the initial Training Set. In this stage, the Training Set is expanded (often iteratively). This is accomplished by selecting training records using one or more of the following methods: simple random sample, manual selection, artificial records, and active learning; labeling the selected records; and adding the labeled records to the Training Set. The Training Set can be optionally updated to adapt the Training Set to collection changes (e.g., additions, deletions, splitting, and the like), and to fix mislabeled Training Set records. In this stage, a training algorithm is run to produce the Predictive Model.

Records are selected by the reviewer to train the system. The reviewer supervises the active learning model with an expert coding the records, and determines whether more system training is needed.

In accordance with the process of this disclosure, one type of Predictive Model is trained as closely as possible to the initial Training Set (from any new data, but trained by an expert) and then apply that Predictive Model once the reviewer is satisfied with the accuracy of the Predictive Model when compared to the Training Set. In other words, accuracy in this context refers to how closely the Predictive Model tracks the Training Set from the expert.

In accordance with this disclosure, the Predictive Model is trained using an expert. Only one model is used, and training is repeated based on expert's feedback and answers to computer training. At 115, training stops once system has reached stability, i.e., when recall is no longer increasing and balance between recall and precision has been attained.

Referring to FIGS. 1-4, Phase 5 at 110 involves updating the Working Test Set. The initial Working Test Set is typically too small to evaluate the Predictive Model, or the Production Set, with the desired level of certainty. It is therefore desirable to select and label additional Working Test Set records and update the Working Test Set to reflect changes in the Collection or in the definition of responsiveness.

Referring to FIGS. 1-4, Phase 6 at 112 involves selecting records for review. Both the Predictive Model and other methods can be used as filters to choose which records to review, and prioritization methods to choose the order in which to review those records. For example, predictive scores or other filters (date, sender/receiver, etc.) can be used within the review platform or prior to loading to the review platform. Predictive scores within the review platform or within the predictive coding platform can be used to create a prioritized review. In this stage, when handling the labeled sets, rules apply as to when records can be added to the labeled sets to avoid creating bias. In this stage, there is an evaluation of the effectiveness of: the Predictive Model, other selection methods, and the overall review pool. In this stage, there is a need to determine which selection methods to use, what order in which to use the methods, when to start using them, and the impact of any Collection changes.

The set of records that has been identified for review is referred to as the Review Pool. In some cases only Review Pool records will be loaded into the review platform. In other cases the entire Collection will be loaded into the review platform and the Review Pool will be a designated subset of that loaded Collection.

Step 6 occurs after training the Predictive Model and applying the rule set to the entire record corpus. In Step 6, records are prioritized for review according to their predictive coding “score”. This score varies from software vendor to vendor but generally correlates to “likelihood of responsiveness” of the record. The entire population is ranked from “Highest” (most likely to be responsive) to “Lowest” (least likely to be responsive).

In Phase 6, a rule set is applied to the record review corpus and all of the records are prioritized from most likely to be responsive to least likely to be responsive. This creates the Review Pool and reviewer batches will start at the top of the priority list.

The finished predictive coding rule set is applied to the entire population of records. The reviewer then ranks the records by relevancy score, and starts designing the review.

In the process of this disclosure, static batch sizes are used when assigning records for review. Records are sent to reviewers in batches of a standard size (250, 500, 2000 records) that does not vary during the review. The size of the batches may be reduced due to the complexity/time of the records for review, but the size of the batch is not dynamically calculated. The batch size is not varied based on responsiveness or accuracy.

The process of this disclosure uses predictive coding software to rank records from most likely to be responsive to least likely to be responsive and starts the review at the top of that priority list. At some point, based on client requirements on recall and precision, the process of this disclosure will stop the human review and produce everything above the cut-off score. Records below the cut-off score will not be reviewed en masse or produced. They will be sampled to verify that they are not responsive and should not be produced. Preferably, the process of this disclosure does not produce without human review. Current best practice in predictive coding requires human verification/confirmation of all records marked for production.

The process of this disclosure uses any machine learning or sampling methodology (agnostic as to technology) to prioritize relevant records and stop review when recall target/cut-off score is attained. Also, the process of this disclosure covers the entire discovery approach, including non-predictive coding records. The calculation of recall is of the entire review, not just the predictive coding portion. Phase 6 is where records are prioritized after applying the predictive coding software and scores.

The process of this disclosure computes total recall by accounting for both the predictive coding review population and the non-predictive coding review population. The process of this disclosure also includes cost or time budgeting, which is a feature of the proportionality calculation. In accordance with the process of this disclosure, recall can be computed often. Preferably, recall is designed around constant monitoring according to recall and the cut-off statistics to determine whether to stop the review or continue with further testing.

In Phase 6, the Predictive Model is applied to entire Review Pool and records are prioritized for review.

Referring to FIGS. 1-4, Phase 7 at 114 involves assessing the software training status, reconsidering resource requirements, and deciding whether to halt training. In this stage, estimates of how the effectiveness of the Predictive Model has changed during training, as well as estimates of the effectiveness of the Review Pool, are used to decide whether further training is necessary. The effectiveness observed for the trained predictive model also allows more precise estimates of resource requirements, and may lead to a change in the effectiveness target.

Referring to FIGS. 1-4, Phase 8 at 116 involves the review of records for production. This is a conventional review process applied to the Review Pool. During this phase, it is preferable to reduce bias by restricting (a) reviewer knowledge of predictive scores, (b) membership in labeled sets, and (c) labels. Quality control is a part of this stage. This stage will utilize a score based quality control. For example, a quality control team may be instructed to quality control all records (or a percentage of records) that are coded as non-responsive but have a score above a certain threshold. In an embodiment, one aggressive approach to predictive coding is to omit manual review for responsiveness entirely, and only conduct a privilege review on the Review Set. This approach may be a cost-saving strategy. The method and system of this disclosure avoid bias specific to the use of predictive coding in review.

In Step 8, the review process is adapted with quality control, batching of records, assigning reviewers, etc. to predictive coding. Records are assigned by squad leader to reviewer teams, starting from the top of the priority list. Reviewers work down the priority list and mark records as “Responsive” or “Not Responsive”. As part of the quality control process, a squad leader will compare a human reviewer's score to the computer's “prediction” and use this as part of the daily quality assurance/quality control performance evaluation. If the human reviewer and the computer disagree and the squad leader agrees with the human reviewer's decision, then the squad leader will notify the predictive coding engineer in charge that the predictive coding process may need improvement.

In Phase 6, the completed predictive model is run on the Review Pool and the records are ranked by relevancy scores from the software. Then, in Phase 8, human confirmation/verification review is performed of the machine coded records.

The review in Phase 8 continues until the reviewers hit a “cut-off” point in the priority list where the records below the cut-off score are considered to be not relevant for purposes of the review. The remaining non-human-reviewed records are sampled to verify this conclusion, but the human review has ended. That criteria is based on an analysis of the trend shown by successive record populations down the priority list.

In the Phase 8 review, if any records are truly duplicates, they will be eliminated from any further review, provided that the reviewer has access to a list of prior reviewed records. Alternatively, a client may eliminate new records that are identical to prior-reviewed records before the review population is provided. Also, there are tools such as “Near Duping” that will gather similar records together. In that case, the process of this disclosure assigns similar records to the same reviewer. This is a common best practice.

Near-dupes are grouped together when Near-Duping software (e.g., like from Equivio) is used. This occurs during the batching process. A batch is generated for reviewers based on the priority list and then the reviewers try to identify near-dupes based on the similarity score created by the near-dupe software program. So, for example, for each record assigned to the reviewer, 1-100+ similar records may be included that may represent earlier drafts or variations of the record. This improves consistency and accuracy of the review. It is a common best practice technique.

The process of this disclosure uses outputs from predictive coding technology (e.g., Equivio or Recommind, etc.) and performs additional calculations related to overall production, for effectiveness measures, proportionality calculator, etc.

Referring to FIGS. 1-4, Phase 9 at 118 involves evaluating the Verification Set and the Production Set and deciding whether to attempt certification at 119. In evaluating the Production Set, the administrator or other responsible entity will periodically use the Working Test Set to estimate the recall (and other effectiveness measures if desired) of the Production Set. These estimates inform the decision of whether to attempt certification. In evaluating the Production Set, the Working Test Set will be used to estimate effectiveness. For each record in the Working Test Set, it will be determined whether or not the record is in the Production Set as well as what the gold standard label for that record. A contingency table can then be produced for the Working Test Set and the desired effectiveness measures can be estimated.

In deciding whether to tentatively stop review and attempt certification, several factors should be considered: For example, the effectiveness of the Production Set as estimated from the Working Test Set should be considered. This is an important factor. Other factors include, for example, the nature of the certification criterion, the possibility of further additions to the Collection, deadlines for rolling productions, review status of recent additions to the Collection, staffing issues, legal guidance, and the like.

The reviewer determines whether the review should continue or stop once it gets near the defined cut-off score. This is a continual evaluation in order to minimize the amount of human review.

Effectiveness/quality of the Production Set is evaluated, constantly, once review starts. Any issues with accuracy of record decisions are fed back into the linear review process at Phase 8, and at Phase 7 if training needs to be re-done or improved.

Referring to FIGS. 1-4, Phase 10 at 120 involves creating the Certification Test Set. The Certification Test Set is a simple random sample from the entire Collection, including both the records in the Production Set and those not in the Production Set. The Certification Test Set is required to be a simple random sample from the final version of the Collection. Therefore, it is advantageous to delay its creation until the Collection has stabilized as much as possible. However, if the Collection does change after the Certification Test Set has been created, then it will need to be updated so that it remains a simple random sample. If rolling productions from a single Collection are to be produced, then the preference is to use a single effectiveness target for the cumulative production, rather than targets for each individual production. This simplifies evaluation, and allows the rolling productions to be carried out in the most cost efficient manner. The Certification Test Set is used only for Certification.

Referring to FIGS. 1-4, Phase 11 at 122 involves certifying the Verification Set and the Production Set. In this stage, the Certification Test Set is used to estimate the effectiveness of the Verification Set and the Production Set, viewed as a classification of the whole Collection. After the Working Test Set indicates that review can stop, all records coded as Responsive in the Working Test Set should be added to the Production Set at 121. All records coded as Responsive in the Training Set should also be added to the Production Set at 121 if that has not already been done. If the lower bound of the confidence interval on effectiveness exceeds the desired value, then the review can be considered complete at 123. If the target effectiveness has not been met, then further review should be continued until the target effectiveness is achieved. Effectiveness should typically be checked no more often than once per thousand records reviewed.

In Step 11, a predictive coding engineer compares human reviewer performance with computer predictions on a global basis to determine whether the records marked for production are ready and correct. The effectiveness of the production set (using recall, precision, elusion, etc.) is measured. The reviewer then verifies that the production set is of sufficient quality and format.

An embodiment of this disclosure involves updating a simple random sample when the Collection changes. There are three simple random samples from the Collection used in predictive coding. What is required from each of them is somewhat different.

One is random samples that are part of the Training Set. The goal of including randomly selected records in the Training Set is to guard against the possibility that seeding and iterative training might miss some important types of records in the Collection. Randomness is used simply as a way to get representative records.

Another is random samples that are part of the Working Test Set. The Working Test Set is used to make statistical estimates, and so its randomness is central to its usefulness. However, its statistical estimates are intended to be used for process management, not external reporting. Therefore, it is acceptable for the Working Test Set to deviate slightly from being a simple random sample if necessary for practicality. Further, since its estimates are not (typically) part of external agreements, there is some flexibility in its necessary size.

Another is random samples that are part of the Certification Test Set. The Certification Test Set has the strictest requirements. It must be a simple random sample at the time it is used to produce Certification results. It is also typically larger than the Working Test Set, and requires the most careful labeling, making updates to it particularly expensive. For this and other reasons, producing the Certification Test Set is delayed as late in the process as possible, and encourages careful consideration of commitments that impinge on it.

Maintaining the appropriate size and statistical properties for a Test Set may require updating that Test Set during review, for any of several reasons. The Collection from which the Test Set is supposed to be a simple random sample may experience additions, deletions, and splitting. Changes in the Collection or in the responsiveness definition may change the richness of the Collection, which may in turn change the desired size of a Test Set. Changes in effectiveness targets during review may change the desired size of a Test Set.

Predictive coding and review platforms are not always designed to make updating random samples easy. The process of this disclosure uses several strategies to minimize the need for such updates including, for example, delaying selection of Test Set records until immediately before labeling, delaying selection and labeling of Test Set records as late in review as possible, using two Test Sets, with the Working Test Set held to less strict standards than the Certification Test Set, and choosing Working Test Set records in two phases when practical. All of these strategies are intended to minimize the number of labeled records that may be wasted, because changes in the Collection made them no longer members of some simple random sample.

Statistical issues are involved in updating simple random samples. The validity of a simple random sample is based on applying a random sampling algorithm to a particular Collection. A simple random sample is valid only with respect to that Collection. If the Collection changes, then a sample updating algorithm must be applied to the old sample and the new Collection, to produce a new sample that is a simple random sample from the new Collection.

An added complexity is that the size of the sample needed is based on the richness of the Collection. A change in the Collection may lead to the richness increasing, decreasing, or staying roughly the same. So when using a sample updating algorithm, it must be specified what minimum size is wanted for the new sample to have. The goal of the sample updating algorithm is to create a new sample of the specified size (or larger) while minimizing the number of new records to be labeled.

Adding records to the Collection has two effects. It changes the richness of the Collection, possibly requiring a change in the size of the desired simple random sample. Also, it changes the composition of the Collection, typically meaning that some new records will need to be labeled and/or that some previously labeled records should be removed, even if the desired size does not change. How substantial those changes are depends on the nature of the additions to the Collection, and whether we are considering the Working Test Set or the Certification Test Set. There are three broad cases described below.

In one case a few records are added, with richness similar to or less than Collection. Re-estimation of resources is not needed in this situation. Updating the Training Set is optional. Updating the Working Test Set is optional. Updating the Certification Test Set is required, and will typically result in selecting and labeling few of the newly added records.

In another case, few records are added and richness is much higher than richness of current Collection. Because responsive records are typically rare, an addition that is dense in responsive records makes updating Labeled Sets more important. On the plus side, if the Working Test Set and/or the Certification Test Set are not yet complete, a re-estimation based on the new richness may allow reducing their target size. Updating the Training Set is highly desirable since there may be responsive records with new properties. Updating the Working Test Set is highly desirable, and the most efficient strategy may involve both selecting and labeling a few of the new records and removing a few of the old records. Updating the Certification Test Set is required, and the most efficient strategy may involve both selecting and labeling a few of the new records and removing a few of the old records.

In another case, many records are added. Resources should be re-estimated, since all Labeled Sets will require substantial updates, in the form of selecting and labeling new records, and potentially removing old ones.

As with additions, removing records changes the composition of the Collection, and typically its richness as well. When records are removed from the Collection, any record no longer in the Collection must be removed from the Working Test Set and Certification Test Set. The remaining records in these sets will constitute a simple random sample from the new Collection. However, typically additional records will have to be added to the simple random sample for it to be of sufficient size again. There are again three broad cases described below.

In one case, few records are removed and richness is similar to or less than Collection. No new labeling is necessary in this case.

In another case, few records are removed and richness is much higher than Collection. Because responsive records are rare, removing even a small set of high-richness records requires re-estimating Test Set sizes and thus necessary resources. Updating the Training Set is optional. In updating the Working Test Set, a few records may be removed, and then many more new ones will need to be selected and labeled, with the test set having a net growth in size. In updating the Certification Test Set, a few records may be removed, and then many more will need to be selected and labeled, with the test set having a net growth in size.

In another case, many records are removed. Re-estimation of resources is necessary. A substantial number of records will need to be selected and labeled for the Working Test Set and Certification Test Set, to bring them back up to the new required size (even when that size is smaller than previously). Updating the Training Set is optional, but highly desirable. In updating the Working Test Set, a few records may be removed, and then many more typically need to be selected and labeled, with the test set having a net decrease in size. In updating the Certification Test Set, a few records may be removed, and then many more will need to be selected and labeled, with the test set having a net decrease in size.

In splitting the Collection, the predictive coding process must be started from scratch for each new Collection, including re-projecting resource requirements. Depending on platform limitations, the existing Labeled Sets may be reused to some degree.

If the definition of responsiveness changes, all the Labeled Sets will need to have their labels checked and corrected if necessary. If the changes are substantial, a new estimate of richness should be computed from the Working Test Set and resources re-estimated if richness has substantially changed.

Platform details that are relevant to additions, deletions, splits, and changes in the responsiveness definition are described below. Producing Test Sets outside of the predictive coding platform will sometimes be necessary to ensure their validity.

With respect to in-platform updating of Test Sets for additions, platforms vary in the ease with which new records can be added to an existing Collection, and the support they provide for updating random samples in response to such additions. The major possibilities are described below.

In one scenario, the platform provides an option that updates an existing simple random sample to be a simple random sample from the expanded Collection.

In a second scenario, scenario 1 does not hold, but the platform allows drawing a simple random sample from just the new records, and adding this sample to the existing simple random sample. This is not the same as scenario 1: combining a simple random sample from the new records with a simple random sample from the old records is not equivalent to drawing a simple random sample from the combined set of records. However, if the two simple random samples have sizes proportional to the sizes of the sets of old and new records, the resulting sample is not too different from what a simple random sample would be. Such a combined sample would be acceptable for the Working Test Set (though might be larger than necessary), but not for the Certification Test Set.

In a third scenario, scenarios 1 and 2 do not hold, but the platform allows drawing additional randomly sampled records from the expanded Collection. The issue in this case is whether there are kludges available to convert scenario 3 to scenario 2. For instance, it might be possible to draw a sample from the expanded Collection, and then delete all but the new portion of that sample. This could salvage scenario 3 for the Working Test Set, but not for the Certification Test Set.

In a fourth scenario, scenarios 1, 2, and 3 do not hold, or the platform does not allow additions to the Collection. In some cases, the lack of capability to deal flexibly with additions to the Collection may require that some other method be used for producing one or both of the Test Sets. In other cases, all additions may need to be handled by defining a new Collection.

With respect to in-platform updating of Test Sets for deletions, if a set of records is removed from the Collection, all that need to be done to preserve the validity of an existing simple random sample is to remove members of the deletion set from the simple random sample. Ideally a platform would automatically, or at user command, update existing random samples to reflect deletions from the sampled Collection. Further, if deleted records have already been labeled, the option to keep them available in case the random sample in the Training Set, without having them treated as part of the Collection, would be desirable to add those records to the Training Set. Unfortunately, predictive coding platforms in practice often do not handle deletion gracefully, particularly in the exposed interface. “Under the hood” manipulations can sometimes accomplish the necessary changes, while in other cases one must simply handle random sampling outside the predictive coding platform. Further, a reduction in Collection size counter intuitively almost always requires labeling more Test Set records.

With respect to in-platform updating of Test Sets for splits, splitting an already-created Collection into two separate Collections is not believed to be supported by any current predictive coding platform. Thus, this would need to be accomplished by a combination of deleting records from the existing Collection and creating a new Collection. The key issues for random sampling are whether label information can be exported from one Collection and imported into the new one, and whether either a set of records from one Collection can be specified as the first records of a random sample for another Collection, or the random sampling mechanism is such that existing random sample records will naturally be the first records of the random sample in the new Collection. It might be true if PRN sampling were used.

With respect to in-platform updating of Test Sets for changes in the responsiveness definition, changing the responsiveness definition is typically well-supported by predictive coding platforms, since going back and changing coding decisions is an inevitable part of any review process. However, increasing the size of random samples due to any resulting richness decrease is typically not directly supported. Much the same issues described above with respect to increasing sample size after other changes then arise, though not complicated by any change in the actual set of records in the Collection.

The usual approach to generating a random sample works like this. A population of N items is put in a list (in any order). A random number generator is used to generate a number between 1 and N, and the item at that position is included in the sample. This process is repeated (ignoring cases where the same random number comes up more than once in simple random sampling without replacement) until a sample of the desired size is produced.

Permanent random number (PRN) sampling reverses this technique. Every item in the population is assigned a random identifier, and the population is sorted by this random identifier. A simple random sample of any size can be produced by simply taking the top items from the sorted list. PRN sampling is widely used in government surveying of businesses, for instance, to achieve desired degrees of overlap in several samples taken over time.

For records, an easy way to associate a permanent random number with each record is to apply a high quality hash function to each record. In fact, if a hash function is used for deduplication, and exact duplicates are removed on that basis, then that hash value can be used as the PRN if only one sample from the Collection is necessary.

If the Collection contains multiple records with identical hash values, then applying a high quality hash function to the unique ID of the record concatenated with the original hash value will produce a new hash value suitable as a PRN. If multiple samples from the same Collection are needed, then multiple hash functions, or additional concatenated strings, can be used. Alternately, random number or strings (e.g. random GUIDs) can be generated and stored with or in each record.

PRN sampling makes updating samples easy to implement with file system or database operations. To create a labeled simple random sample, sort Collection by the PRN and label the first n items. To update the sample for Collection additions, sort the new Collection by PRN, determine the new sample size n′, label the unlabeled items among the first n′ items, and use the first n′ items as the simple random sample. To update the sample for Collection deletions, remove from the sorted list those records no longer in the Collection, determine the new sample size n′, label the unlabeled items among the first n′ items, and use the first n′ items as the simple random sample. To split a sample to correspond to a split Collection, split the PRN sorted list into two lists for the new Collections, determine the new sample sizes n1 and n2 for the two new Collections, label the unlabeled items among the first n1 items for the first list and the first n2 items for the second list, and use the first n1 items from the first list and the first n2 items from the second list as the new random samples. To update the sample for a change in responsiveness definition, update the labels of all labeled examples, determine the new sample size n′, label the unlabeled items among the first n′ items, and use the first n′ items as the simple random sample.

Some labeled items may be omitted from the new sample. Information on them should be retained, however, as later Collection changes might lead to them being brought back into the sample.

PRN sampling is particular appealing for use in predictive coding and review platforms that do not provide adequate sample updating, but do expose a database interface. All the operations above (with the exception of the human judgment involved in determining the new sample size) can be implemented with simple database commands. In the worst case, command line utilities and file system commands could be used to generate samples.

As with any sample updating scheme, a decision must be made on the size of the updated sample. PRN sampling does have the advantage that it is easy to generate a preliminary sample for estimating richness. One simply goes down the PRN sorted list until the first unlabeled record is reached. This set typically stays reasonably large after deletions, splits, and changes in the responsiveness definition (assuming the Working Test Set was already created). After additions to the Collection, however, some labeling at the top of the list will be necessary before one again has a richness estimate.

Several factors afforded by the process of this disclosure affect differentiators, including time, cost and defensibility, with respect to processes using similar predictive coding software. The differentiators affected by each factor are discussed herein.

A first factor is that the process of this disclosure accounts for non-predictive coding prioritization in making decisions. The process of this disclosure specifies, and provides software for, making statistically valid estimates of the current and projected Production Set recall, along with other effectiveness measures. These estimates give credit for prioritization of records by methods other than predictive coding. These estimates inform key decisions, including: when to stop training, when to put some version of the predictive model into use, what threshold to use for a predictive model/how many records to queue for review, when to stop review, and the like.

In contrast, some vendor software provides estimates only of the effectiveness of the predictive model, not the Production Set. Also, some vendor processes that do provide estimates of Production Set effectiveness do so too late to inform most decisions, or use effectiveness measures which do not provide the information necessary for decision making.

The positive impacts resulting from the first factor afforded by the process of this disclosure include, for example, (i) stop training of predictive model earlier (since doesn't need to be as good); less training data labeled reduces cost and time to completion; (ii) choose appropriate threshold for prioritization by predictive coding; avoid prioritizing too many: reduces hosting costs; avoid prioritizing too few: avoids rework (additional prioritization) and thus reduces cost and time to completion; (iii) start review earlier (if alternate means of prioritization are available); reduces time to start and time to completion; and (iv) stop review earlier (since have estimates of actual Production Set effectiveness); reduces review costs (fixed and per-record) and time to completion.

Scenarios where the first factor afforded by the process of this disclosure makes a difference include, for example, where the client needs to prioritize certain custodians or other groups of records, where the client wants to use manual search as well as predictive coding, and the like. The clients can satisfy their desire to do so, and be informed that it will save them costs as well.

Other embodiments that can further enhance value to a client afforded by the first factor of this disclosure include, for example, define Review Pool (e.g., Prioritized Set) and add estimation of its effectiveness; formalize decision criteria and build calculators; incorporate explicit cost estimation in decision criteria; discuss nature and timing of non-PC-based prioritization; discuss how personnel can do (or advise on) searches for prioritization, and evaluate whether they are saving cost; and the like.

A second factor is that the process of this disclosure allows the use of multiple versions of the Predictive Model. As discussed with the first factor, the process of this disclosure makes use of multiple forms of prioritizing records for review. These can include different versions of the Predictive Model. This is desirable because early in the training of a model, it can often already achieve good precision at sufficiently high thresholds, even though it is not good enough to reach the desired recall target with high precision. In an embodiment, the process of this disclosure can utilize software to do all effectiveness estimation outside predictive coding platform if necessary.

In contrast, with respect to other processes, their standard process assumes only one use of predictive model. Also, their software makes it difficult to alternate training and effectiveness estimation.

The positive impacts resulting from the second factor afforded by the process of this disclosure include, for example, start review earlier; reduces time to start and time to completion; and the like.

Scenarios where the second factor afforded by the process of this disclosure makes a difference include, for example, all prioritization will be done using predictive coding; high time pressure to get started; and the like.

Other embodiments that can further enhance value to a client afforded by the second factor of this disclosure include, for example, provide more explicit guidance as to when to put first/next version of Predictive Model into use (Predictive Model costs; Predictive Model rate of review and current state of review pool); implement all this in a calculator to estimate when worth putting first/next version of Predictive Model into use; and the like.

A third factor is that the process of this disclosure flexibly and efficiently handles changes to the Collection. The process of this disclosure is designed to assume additions to and deletions from the Collection, as well as the possibility of splitting the Collection. Numerous aspects and choices involved with the process of this disclosure reflect this focus including, for example, separate software tool for estimation of effectiveness; logging of all changes to collection; use of permanent random number sampling when needed to simplify keeping test sets up to date; scheduling labeling of test set records as late as possible; and the like.

In contrast, standard vendor processes often do not account for additions to or deletions from the collection. Also, vendor personnel are often unclear on how their software handles collection changes and/or the statistical implications of those changes.

The positive impacts resulting from the third factor afforded by the process of this disclosure include, for example, less confusion and delay when collection changes (reduces cost and time to completion); better estimates of effectiveness throughout process (reduces cost and time to completion); reduces work and rework when desirable to split collection (reduces cost and time to completion); certification Test Set always a simple random sample from final collection (increases defensibility); and the like.

Scenarios where the third factor afforded by the process of this disclosure makes a difference include, for example, cases where new records arrive during predictive coding training and/or review; cases where need to review certain records is under debate during review; cases where there are subsets of records that would be better handled as a separate collection; and the like.

Other embodiments that can further enhance value to a client afforded by the third factor of this disclosure include, for example, finish description of how permanent random number sampling is used, particularly in combination with relativity; provide explicit guidance on whether collection changes are large enough to require re-estimating richness, updating Working Test Set, etc.; build calculator incorporating above; define stratified sampling methods to combine samples from different versions of collection; and the like.

A fourth factor is that the process of this disclosure makes decisions that maximize progress toward client-specified effectiveness goals. The process of this disclosure allows estimating client-specified effectiveness measures at all points, as well as estimating effectiveness of components that contribute to these. It provides software to support this estimation. Estimates are made taking into account all forms of prioritization as discussed with the first factor above. The process of this disclosure also takes into account estimates of human review effectiveness.

In contrast, with respect to other processes, their software and/or process configurations use effectiveness measures which are mismatches with client needs. Also, their software/process looks only at effectiveness of the predictive model. Further, they do not take effectiveness of manual review into account.

The positive impacts resulting from the fourth factor afforded by the process of this disclosure include, for example, better decisions (avoid starting review too early: avoid manual review of low richness docs: reduce cost; avoid starting review too late: reduce time to completion; avoid stopping review too early: avoid need to restart review: reduce cost; improve defensibility by avoiding failed Certification attempts; avoid stopping review too late: reduces cost and time to completion); better insight into rate of progress toward goal (more predictability (of cost and time); training set size is appropriate for effectiveness goal (reduces cost and time to completion if smaller size will suffice); and the like.

Scenarios where the fourth factor afforded by the process of this disclosure makes a difference include, for example, where the client wants to use different effectiveness measure than the default for the software vendor and/or the default used for the process of this disclosure; client has strict specifications for effectiveness (perhaps negotiated with receiving parties); client has particular needs to understand and report on progress toward goal; and the like.

Other embodiments that can further enhance value to a client afforded by the fourth factor of this disclosure include, for example, support additional effectiveness measures; analyze how needs for sampling change when recall is not client focus; provide guidance for explicitly estimating time to completion and/or cost; formalize advice; create calculator for estimating time to completion and/or cost under different decisions; and the like.

A fifth factor is that the process of this disclosure produces and records an unbiased estimate of the Production Set effectiveness. The process of this disclosure provides for a Certification Test Set that is used only in certifying the final result, and this is isolated from potential sources of bias that the Working Test Set is exposed to. The process of this disclosure also specifies keeping careful track of changes to the Collection and reasons for decisions.

In contrast, with respect to other processes, their standard process configurations use the same test set for process control and evaluation. Those that define the equivalent of a Certification Test Set sometimes cripple its usefulness, e.g., by sampling only from unreviewed records.

The positive impacts resulting from the fifth factor afforded by the process of this disclosure include, for example, increase defensibility, and the like.

Scenarios where the fifth factor afforded by the process of this disclosure makes a difference include, for example, in highly adversarial settings, and the like.

Illustrative entities involved in the method of this disclosure include, for example, the owner or proprietor of the method, client, technology vendor, counsel, and the like. As described herein, FIG. 3 depicts who is in control in the eleven high level phases involved in the method of this disclosure. In an illustrative discovery project in the context of litigation and other situations where disclosure of stored information is compelled or required by law or necessity, the client and technology vendor 302 are typically in control in Phase 1, counsel 304 is typically in control of Phases 4 and 5, the owner or proprietor 306 is typically in control of Phases 7-11, and the owner or proprietor and counsel 308 are typically in control of Phases 2, 3 and 6.

As described herein, FIG. 4 depicts what is being offered in the art in the eleven high level phases involved in the method of this disclosure. In discovery management methods offered in the art, a semblance of Phases 1, 6 and 7 is offered by conventional tools (402). A semblance of Phases 2, 4 and 5 is offered in the art but such semblance differs from Phases 2, 4 and 5 of this disclosure (404). Phases 3 and 8-11 are not offered in the art (406 and 408).

Other embodiments that can further enhance value to a client afforded by the fifth factor of this disclosure include, for example, more explicit guidance on how to handle failing of initial Certification Test, and the like.

While we have shown and described several embodiments in accordance with our disclosure, it is to be clearly understood that the same may be susceptible to numerous changes apparent to one skilled in the art. Therefore, we do not wish to be limited to the details shown and described but intend to show all changes and modifications that come within the scope of the appended claims.

What is claimed is:

1. A computer-implemented method comprising:
specifying a set of categories;
receiving a collection of records;
separating the collection of records into at least a first portion of records and a second portion of records;
classifying the collection of records which comprises at least:
classifying the first portion of records using supervised machine learning; and
classifying the second portion of records by other than supervised machine learning;
creating a certification test set by drawing a simple random sample from the collection of records;
manually labeling the certification test set by associating each record in the certification test set with a desired category for that record; and
comparing the category assigned to each record of the certification test set by the classifying of the collection with the category assigned to each record of the certification test set by the manual labeling of certification test set.

2. The method of claim 1 further comprising:
computing an estimate of the effectiveness of the classification of the collection.

3. The method of claim 1 wherein classifying the first portion of records using supervised machine learning comprises:
producing a labeled working test set by:
selecting an unlabeled working test set by drawing a random sample from the first portion of records; and
manually labeling the working test set by associating each record in the unlabeled working test set with a desired category for that record;
producing a labeled training set by:
selecting an unlabeled training set by selecting one or more records that are not in the working test set; and
manually labeling the unlabeled training set by associating each record in the unlabeled training set with a desired classification of that record;
learning a classifier by applying supervised machine learning to the labeled training set;
classifying the working test set by applying the classifier to the unlabeled working test set;
comparing the labeled working test set and the classified working test set; and
choosing whether or not to increase the unlabeled training set by selecting more records that are not in the working test set to produce a larger labeled training set based on the comparison of the labeled working test set and the classified working test set.

4. The method of claim 1 wherein classifying the collection of records further comprises:
creating a production set by consolidating all records from the first portion that were classified into one or more of the set of categories and the records from the second portion that were classified into one or more of the set of categories.

5. The method of claim 1 wherein classifying the collection of records further comprises:
producing a review set by consolidating records from the first portion that were classified into one or more of the set of categories and the records from the second portion that were classified into one or more of the set of categories;
manually reviewing one or more of the records included in the review set and optionally replacing one or more of the categories assigned to those records with one or more different categories from the set of categories; and
creating a production set from one or more of the records in the review set.

6. The method of claim 3 further comprising:
using the working test set to estimate the effectiveness of the review set.

7. The method of claim 6 wherein the measure of effectiveness is recall, precision, Van Rijsbergen's F-measure, accuracy, error rate, or elusion.

8. The method of claim 3 further comprising:
using the working test set to estimate the effectiveness of the production set; and
choosing whether or not to attempt certification based on the estimated effectiveness of the production set.

9. A computer-implemented system comprising:
a repository comprising a collection of records;
one or more processors configured to:
specify a set of categories;
receive the collection of records;
separate the collection of records into at least a first portion of records and a second portion of records;
classify the first portion of records using supervised machine learning; and
classify the second portion of records using other than supervised machine learning;
create a certification test set by drawing a simple random sample from the collection of records;
allow for manual labeling the certification test set by associating each record in the certification test set with a desired category for that record; and
compare the category assigned to each record of the certification test set by the classifying of the collection with the category assigned to each record of the certification test set by the manual labeling of the certification test set.

10. The system of claim 9 wherein the one or more processors are further configured to:
compute an estimate of the effectiveness of the classification of the collection.

11. The system of claim 9 wherein the one or more processors are further configured to classify the first portion of records using supervised machine learning to:
produce a labeled working test set by:
selecting an unlabeled working test set by drawing a random sample from the first portion of records;
produce a labeled training set by:
allow for manually labeling the working test set by associating each record in the unlabeled working test set with a desired category for that record;
selecting an unlabeled training set by selecting one or more records that are not in the working test set;
allow for manually labeling the unlabeled training set by associating each record in the unlabeled training set with a desired classification of that record;
learn a classifier by applying supervised machine learning to the labeled training set;
classify the working test set by applying the classifier to the unlabeled working test set;
compare the labeled working test set and the classified working test set; and
choose whether or not to increase the unlabeled training set by selecting more records that are not in the working test set to produce a larger labeled training set based on the comparison of the labeled working test set and the classified working test set.

12. The system of claim 9 wherein the one or more processors are further configured to classify the collection of records to:
create a production set by consolidating all records from the first portion that were classified into one or more of the set of categories and the records from the second portion that were classified into one or more of the set of categories.

13. The system of claim 9 wherein the one or more processors are further configured to classify the collection of records to:
produce a review set by consolidating records from the first portion that were classified into one or more of the set of categories and the records from the second portion that were classified into one or more of the set of categories;
allow for manually reviewing one or more of the records included in the review set and optionally replacing one or more of the categories assigned to those records with one or more different categories from the set of categories; and
create a production set from one or more of the records in the review set.

14. The system of claim 11 wherein the one or more processors are further configured to:
use the working test set to estimate the effectiveness of the review set.

15. The system of claim 14 wherein the measure of effectiveness is recall, precision, Van Rijsbergen's F-measure, accuracy, error rate, or elusion.

16. The system of claim 11 wherein the one or more processors are further configured to:
use the working test set to estimate the effectiveness of the production set; and
choose whether or not to attempt certification based on the estimated effectiveness of the production set.
